(19) United States
(12) Patent Application Publication
(10) Pub. No.: US 2008/0309088 A1
(43) Pub. Date: Dec. 18, 2008

(54) Methods and Apparatus for Power Generation

(76) Inventors: Emmanuel Agamloh, Raleigh, NC (US); Alan Wallace, Corvallis, OR (US); Patricia May Wallace, Corvallis, OR (US); Manfred Dittrich, Corvalis, OR (US); Annette von Jouanne, Corvallis, OR (US); Kenneth Rhinefrank, Corvallis, OR (US)

Correspondence Address: KLARQUIST SPARKMAN, LLP, 121 SW SALMON STREET, SUITE 1600, PORTLAND, OR, 97204, US

(21) Appl. No.: 11/912,134

(22) PCT Filed: Apr. 19, 2006
(86) PCT No.: PCT/US2006/014848

§ 371 Date: Jul. 7, 2008

Related U.S. Application Data
(60) Provisional application No. 60/673,209, filed on Apr. 19, 2005.

(51) Int. Cl. F03B 13/10

(52) U.S. Cl. 290/53

(57) ABSTRACT

Motion of a first component in response to waves is converted to rotary motion of a member of a second component. The two components are magnetically coupled to each other. The relative linear motion of the components causes energy to be transmitted from waves between the two components via the magnetic coupling, and thus no mechanical connection is required for the transmission. This can allow for wave energy conversion without a need for hydraulic or pneumatic systems. Applications for technologies described herein include ocean wave energy converters (OWEC) for generating electricity from wave energy.

### CROSS REFERENCE TO RELATED APPLICATION

This application claims the benefit of U.S. Provisional Patent Application No. 60/673,209 filed on Apr. 19, 2005, which is incorporated herein by reference.

### ACKNOWLEDGEMENT OF GOVERNMENT SUPPORT

At least some research related to this application was funded by Oregon Sea Grant, contract numbers R/Ec-11-PD and r/Ec-13-PD. The U.S. Government may have some rights in this invention.

### FIELD

This application relates to generating electricity from ocean wave energy.

### BACKGROUND

Ocean waves are a potential source of energy for generating electricity. Commonly proposed energy extraction techniques are often based on hydraulic or pneumatic intermediaries that can require high maintenance costs and are often prone to failure. Under operating conditions such as heavy seas, the intermediaries can be damaged by excessive force of the waves.

### SUMMARY

Linear motion in response to waves can be converted to rotary motion by moving a first component that is magnetically coupled to a second component. The relative linear motion of the components causes energy to be transmitted from waves between the two components via the magnetic coupling, and thus no mechanical connection is required for the transmission. This can allow for wave energy conversion without a need for hydraulic or pneumatic systems. Applications for technologies described herein include ocean wave energy converters (OWEC) for generating electricity from wave energy. Additionally, the technologies can be used generally in situations where a conversion between linear and rotary motion is desired.

In one embodiment, a system for converting wave motion to rotary motion (the system being at least partially immersed in a liquid) includes a first component, the first component having an overall buoyancy relative to the liquid, a second component slidably coupled to the first component, and at least one screw rotatably supported by the second component. The first component is configured to slide relative to the second component in response to a force from waves that is exerted on the first component. The first component is magnetically coupled to the screw, and a sliding of the first component relative to the second component in at least one direction causes a rotation of the screw. The sliding of the first component relative to the second component can be relative linear motion.

In a further embodiment, the first component can include a ferrous metal, and the second component can also include a magnet and a ball screw nut, where the ball screw nut is generally coaxial with the screw, and where the ferrous metal is configured to transfer the force to the ball screw nut through the magnet, which can be a ring magnet. The second component can also include a generator, and the screw can be configured to transfer rotary motion of the screw to the generator. The magnet can be one of a plurality of magnets, and where at least two magnets of the plurality of magnets are separated by a metal pole piece. In one embodiment, the ferrous metal of the first component is generally cylindrical in shape and has one or more salient features.

An additional embodiment comprises two or more second components which can be configured to transfer energy from the screws of the second components to a generator.

In another embodiment, the first component also includes a magnet, wherein the second component further also includes a ferrous metal mechanically coupled to a ball screw nut, and wherein the magnet is configured to transfer the force to the ball screw nut through the ferrous metal. Instead of a ball screw, a roller screw can be used.

In another embodiment, the first component includes a float, and the second component includes a spar. Desirably the spar in one form is approximately neutrally buoyant relative to the liquid. The float can include an opening, such as a central opening, into which the spar is inserted, and the system can also include a mooring system for anchoring the first and second component at an offshore area. The second component can also include a generator coupled to the screw and adapted to generate electricity in response to rotation of the screw, with electrical conductors configured to transmit electricity to a location that is remote from the first and second components. The second component can comprise a hollow interior, and the screw can be entirely contained in the hollow interior to eliminate the requirement of working seals to prevent liquid from entering the interior of the second component.

In a further embodiment, the first component includes one or more magnets, and the screw includes one or more materials exhibiting generally high electrical resistance and generally low magnetic resistance, such as a silicon iron alloy. The first component can include at least two pole shoes adjacent to the one or more magnets, wherein the pole shoes comprise a main piece and a thread, and wherein the thread extends along at least part of the main piece. The main piece can have a length, and the thread can extend in a generally non-parallel manner along at least part of the length. The at least two pole shoes can include a first pole shoe with a top side and a bottom side, wherein the one or more magnets comprise a first magnet having a north pole and a south pole and a second magnet having a north pole and a south pole, and wherein the north pole of the first magnet is adjacent to the top side of the first pole shoe and the north pole of the second magnet is adjacent to the bottom side of the first pole shoe. The pole shoes can be made of one or more materials exhibiting generally high electrical resistance and generally low magnetic resistance. The screw has a longitudinal axis, and the pole shoes generally extend around the longitudinal axis.

Another embodiment is an ocean wave energy conversion system including a float and a spar. The spar desirably includes a tube and a screw inside the tube, wherein the float and the spar are configured to undergo relative linear motion as a result of a force applied to the float, and wherein the relative linear motion causes the kinetic energy to be transferred from the float to the screw substantially without a mechanical connection between the float and the spar. The float is magnetically coupled to the spar and can be configured to become magnetically decoupled from the spar when a threshold force is applied to the float. A generator can be mechanically coupled to the screw.

In another embodiment, a system for converting wave motion to electricity (where the system is at least partially immersed in a liquid) includes a float, the float having an overall buoyancy relative to the liquid; a spar, the spar having an approximately neutral buoyancy relative to the liquid; a screw rotatably supported by the spar component; and a generator. The float is configured to undergo linear movement relative to the spar in response to a force from waves that is exerted on the float. The float is magnetically coupled to the screw, and the movement of the float relative to the spar causes a rotation of the screw, and the screw is configured to transfer rotary motion of the screw to the generator. The system can also include a clutch that is mechanically coupled to the screw and the generator.

In this application, indefinite articles such as “a” or “an” and the phrase “at least one” encompass both singular and plural instances of objects. For example, when describing a group of multiple objects, “an object” includes one or more than one of the multiple objects.

This Summary is provided to introduce a selection of concepts in a simplified form that are further described below in the Detailed Description. This Summary is not intended to identify key features or essential features of the claimed subject matter. The foregoing and other objects, features, and advantages of the invention will become more apparent from the following detailed description, which proceeds with reference to the accompanying figures.

### BRIEF DESCRIPTION OF THE DRAWINGS

FIG. 1A shows a side view of one embodiment of an ocean wave energy converter system.

FIG. 1B shows a top view of the ocean wave energy converter system of FIG. 1A.

FIG. 2A shows a side cross-section view of one embodiment of an ocean wave energy converter system.

FIG. 2B depicts a side cross-section view of a magnet piston assembly.

FIG. 2C depicts a side cross-section view of an alternate embodiment of the system of FIG. 2A.

FIG. 3 depicts side cross-section views of example magnet configurations for a magnet piston assembly.

FIG. 4 depicts a plot of example finite element analysis results for some configurations of FIG. 3.

FIG. 5 depicts a plot of example generator test results of generator rotation speed as a function of thrust.

FIG. 6 depicts a plot of example generator test results of generator current as a function of thrust.

FIG. 7 depicts a plot of example generator test results of generator efficiency as a functions of generator power output.

FIG. 8 depicts an example equivalent circuit of a permanent magnet synchronous generator.

FIG. 9 shows a graph of simulated voltage generation for the system of FIG. 2A.

FIG. 10 shows a sample oscilloscope waveforms showing a no-load voltage generation for the system of FIG. 2A.

FIGS. 11A-11C show sample oscilloscope waveforms from test results of the system of FIG. 2A for output voltage, output current, and output power, respectively.

FIGS. 12A-12C show sample oscilloscope waveforms from irregular wave test results of the system of FIG. 2A for output voltage, output current, and output power, respectively.

FIG. 13A shows a cross-section side view of one embodiment of an ocean wave energy converter system.

FIG. 13B shows a close-up cross section side view of a magnet assembly and center screw.

FIG. 13C shows a close-up cross section side view of a magnet assembly.

FIG. 13D shows a top cross-section view of the embodiment of FIG. 13A.

FIG. 14A shows a side view of one embodiment of an ocean wave energy converter system featuring multiple spars.

FIG. 14B shows a top view of the system of FIG. 14A.

FIG. 14C shows a bottom view of the system of FIG. 14A.

### DETAILED DESCRIPTION

### System Overview

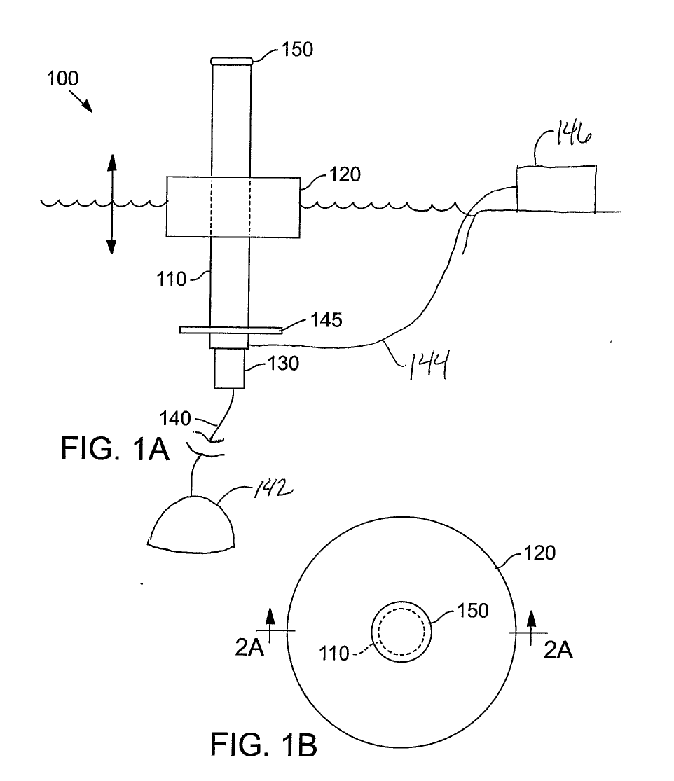

FIG. 1A shows a side view of one embodiment of a buoy generator system (i.e., an OWEC system) 100. The buoy generator system 100 comprises an elongated spar 110 and a float 120. Spar 110 can have a cross section that is round, square, or a number of other shapes, is desirably at least partially hollow, and is preferably constructed of a material that can withstand ocean conditions for a relatively long period of time, such as PVC or composite material. Float 120 is coupled to spar 110 for movement relative to the spar. Desirably the float 120 encircles spar 110 at least in part, but preferably entirely, and can be comprised of any number of buoyant materials as are well known in the art. System 100 can further comprise a ballast weight 130 and a tether 140. FIG. 1A shows tether 140 as being connected to ballast weight 130, but it can also be connected to other parts of system 100, e.g., to spar 110. The remote end of tether 140 is connected to a mooring system 142, which can be any system or arrangement that allows the system 100 to maintain a relatively constant geographic position. For example, the mooring system could comprise a weight such as an anchor or pilings. An electric cable 144 carries electricity from the system 100 to another location, e.g., a shore-based electric facility 146. The top end of spar 110 can be sealed by, for example, a cap 150 to protect its contents from the elements. Spar 110 is preferably configured such that it (with its contents) is approximately neutrally buoyant. System 100 can also comprise a wave deflector or wave motion resistor, such as a wave plate 145, which can be attached or coupled to spar 110, usually at a right angle to spar 110. However, wave plate 145 can also be attached at other angles. Wave plate 145 can provide a dampening force to improve a desirable relative linear motion of float 120 and spar 110. FIG. 1B shows a top view of system 100.

Generally, generator system 100 can be moored offshore in an area where waves are common. As waves propagate past system 100, the waves move float 120 generally upwardly and downwardly relative to and along spar 110. System 100 converts at least some of the relative motion provided by the waves to rotary motion, which is used to turn an electric generator. As will be shown in example embodiments below, system 100 can accomplish this conversion with float 120 and with a power take-off (PTO) system (not shown) inside spar 110. Preferably, there is a magnetic coupling, but no mechanical coupling, between float 120 and the PTO system inside spar 110 that requires a breach of the wall of spar 110. (In this application, the term “coupled” encompasses both the direct interconnection of elements and also their indirect connection through or by one or more components.)

It should be noted that although the motion of float 120 to spar 110 can be described and is often described in the application as “relative linear motion,” other types of motion can also be used. For example, if spar 110 is curved, float 120 can slide along spar 110 in an arcuate motion. In some embodiments, float 120 cans spin relative to spar 110, but these spins can be dampened by the inertia of float 120, which can be designed to be larger than that of spar 110.

One potential advantage of relying on a magnetic connection (rather than a mechanical connection) is increased durability in severe conditions (e.g., rough seas) of the systems described above. For example, float 120 can be configured to “slip” when a force exceeding a selected threshold is applied to it. When the rough see conditions subside, it can slide back into place on spar 110 and resume normal operation. Cap 150 and plate 145 prevent total separation of float 120 and spar 110 in this example.

### System Using a Contact-Less Force Transmission System

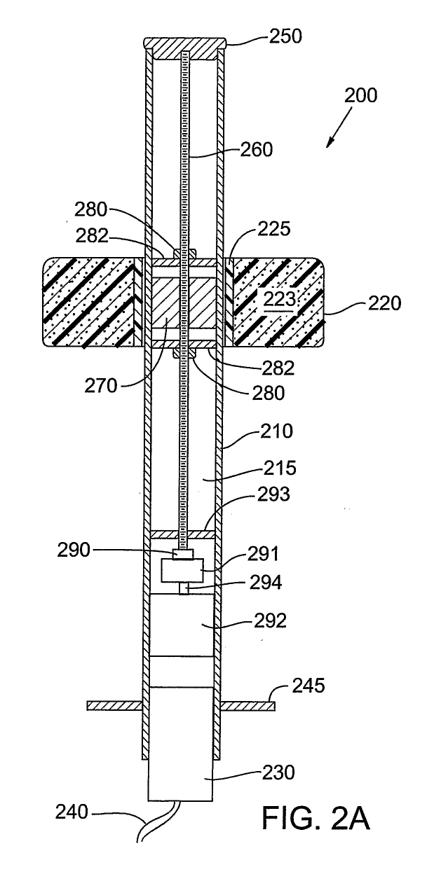

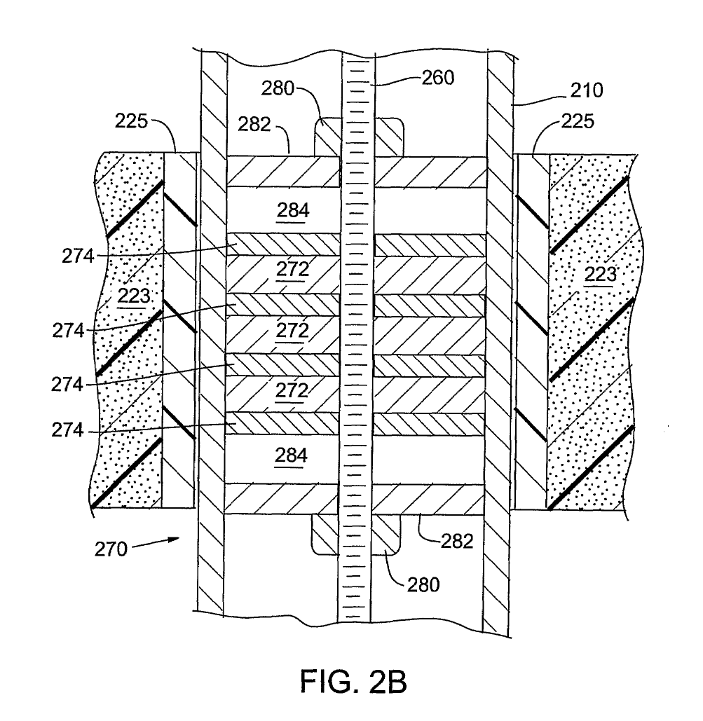

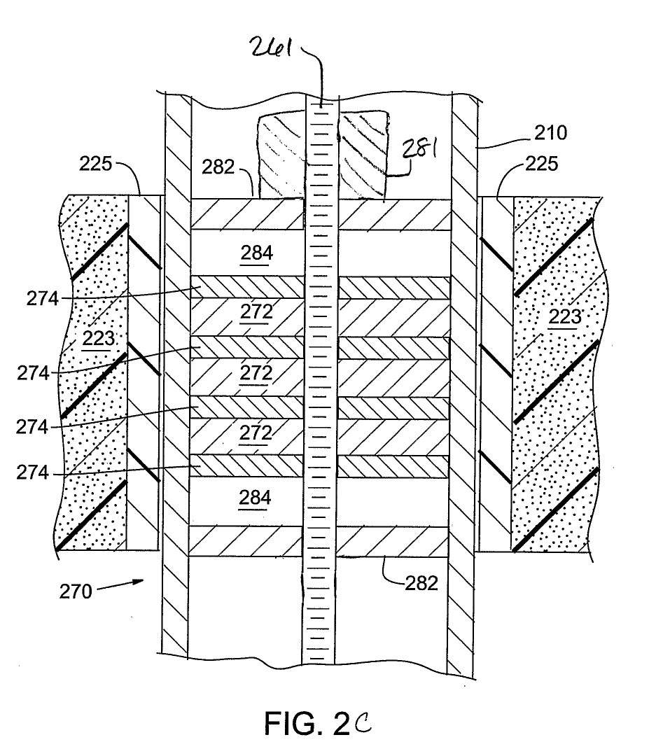

FIG. 2A shows a side cross-section view of system 200 (taken along the lines 2A-2A indicated in FIG. 1B), which is one embodiment of system 100 of FIG. 1. In this particular embodiment, float 220 comprises air or other buoyant material 223 formed around a concentric cylinder 225 of a ferrous metal such as steel. Cylinder 225 can be the same height as buoyant material 223, or it can be taller or shorter. Spar 210 forms a cavity 215 which contains at least one ball screw 260, which can be coaxial with spar 210. Ball screw 260 can be held in place by cap 250 and desirably is rotatably coupled thereto by a bearing (not shown), but desirably not exposed to the exterior of the cap. In one embodiment, cap 250 is large enough to prevent float 220 from sliding off of spar 210 in, for example, rough seas. A magnet piston assembly 270 is mounted on ball screw 260. System 200 can also comprise a wave plate 245.

FIG. 2B depicts a side cross-section view of magnet piston assembly 270 in more detail. Magnet piston assembly 270 comprises one or more permanent magnets 272. Multiple magnets 272 can be interspersed with pole pieces 274, and both are preferably concentric with ball screw 260. It is also preferable, but not required, that magnets 272 and pole pieces 274 be generally ring-shaped and completely encircle ball screw 260. As defined herein, a magnet 272 that is described as “ring-shaped” or as a “ring magnet” can comprise two or more magnets configured to approximate the magnetic performance of a one-piece ring magnet. FIG. 2B depicts gaps 284 between pole pieces 274 and harness 282. These gaps can be of varying sizes or non-existent.

Generally speaking, magnets 272, cylinder 225 and ball screw 260 together comprise a ferromagnetic reluctance device, sometimes herein called a contact-less force transmission system (CFTS). Magnets 272 squeeze magnetic flux radially through a central pole piece into cylinder 225. As float 220 (and cylinder 225) moves up and down, a reluctance force develops and is transmitted from cylinder 225 to magnets 272 through the magnetic field that develops between these components. By means not shown in FIG. 2B, magnets 272 and pole pieces 274 are mechanically connected (e.g., by welding, fasteners or other connections) to a harness 282 and one or two ball screw nuts 280. Nuts 280 are concentric with ball screw 260. As float 220 moves up and down, magnet piston assembly 270 is pulled up and down, pushing or pulling ball screw nuts 280 along ball screw 260, causing ball screw 260 to rotate. Linear motion is thus converted to rotary motion. It should be noticed that that rotary motion can be converted to linear motion by generally reversing this process, e.g., by rotating screw 260 to cause relative linear motion of cylinder 225.

Returning to FIG. 2A, the rotary motion of ball screw 260 turns a coupling 290 and a clutch 291. Clutch 291 can be a one-way clutch or a two-way clutch. Direct, clutchless coupling is a less-desirable approach. Plate 293 can be added to cavity 215 to protect coupling 290 and clutch 291 from impact with, for example, ball screw nut 280. Other alternative stop mechanisms can be used. Clutch 291 turns a shaft 294 on electric generator 292. Accordingly, coupling 290 and clutch 291 comprise one form of an exemplary power take-off (PTO) system. Although this particular embodiment depicts coupling 290, clutch 291 and generator 292 as being at the bottom end of spar 210, they can also be arranged at the top of spar 210. Additionally, in the embodiment depicted in FIG. 2A, generator 292 is small enough to fit inside spar 210. This can allow for a greater range of travel of float 220 along the length of spar 210. In other embodiments, generator 292 can be positioned outside of spar 210. In such an embodiment, generator 292 can have a diameter greater than that of spar 210.

In another embodiment, magnets 272 and metal plates 274 are not inside spar 210, but are integrated into float 220 in place of cylinder 225. Cylinder 225 is positioned in spar 210 and mechanically connected to harness 282 and ball nuts 280, approximately where magnets 272 and metal plates 274 are in the embodiment described above.

FIG. 2C depicts another embodiment of system 200. In this particular embodiment, ball screw 260 and ball screw nuts 280 are replaced with a screw shaft 261 and a roller screw nut 281, respectively. As roller screws are well known in the art, the inner workings of roller screw nut 281 are omitted from FIG. 2C. As float 220 moves up and down, magnet piston assembly 270 is pulled up and down, pushing or pulling roller screw nut 281 along screw shaft 261, causing screw shaft 261 to rotate. In one embodiment, a roller screw nut 281 is on each end of harness 282.

Similar to system 100 of FIG. 1, system 200 can contain a ballast weight 230 and can be kept in place using a tether 240. In one embodiment, sea water can be used as ballast, which can allow for tuning of the ballast weight according to output power and sea state.

As mentioned above, in some embodiments float 220 can be configured to “slip” when a force exceeding a selected threshold is applied to it. In one embodiment, a control system (not shown) can cause generator 292 to rotate ball screw 260, causing magnet piston assembly 270 to move and “reengage” cylinder 225.

Although some embodiments described in this application (e.g., system 200) feature the CFTS as part of an ocean wave energy converter, the CFTS is also more generally applicable for other applications where there is a need to translate generally linear motion to generally rotary motion, or vice versa.

### Configurations of the Contact-Less Force Transmission System Components

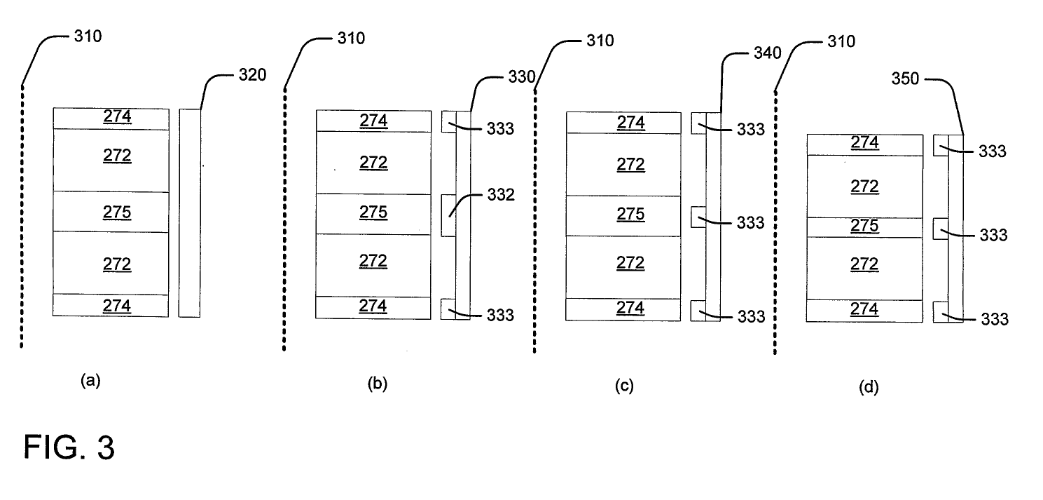

FIG. 3 shows side cross-section views of four exemplary configurations (a)-(d) for magnets 272, pole pieces 274 and cylinder 225 of system 200. Those of skill in the art will recognize other possible configurations. Each configuration depicted in FIG. 3, is shown relative to a line of axial symmetry 310 that is generally coaxial to spar 210 and ball screw 260.

Of the four designs shown, design (a) has a non-salient cylinder 320, while the other three designs have cylinders 330, 340, 350 with salients 332, 333, which are raised features protruding from the cylinders. In designs (a)-(c), the middle pole piece 275 is approximately twice as thick as the other pole pieces 274. An arrangement such as this can be used to create a symmetrical system of equal flux linkage to all phases in order to produce balanced two- or three-phase voltages. Design (d) features pole pieces 274 and middle pole piece 275 that are of approximately equal axial length. Salient 332 on cylinder 330 of design (b) is approximately twice as long (axially) as the other two salients in that design. In designs (c) and (d), salients 333 in each design are of approximately equal size.

In one group of tests conducted on these designs, it was shown that cylinders 330, 340, 350 with salients were generally better than the non-salient cylinder 320 at transmitting thrust to the magnets 272. This group of tests also showed that the thrust transmission of designs (b) and (c) were not significantly different.

In one embodiment, four ring-type, NdFeB magnets with the following dimensions were used: external diameter, 100 mm; internal diameter 50 mm; axial thickness, 25 mm. The magnets were stacked axially with soft-iron ring-shaped pole pieces 10 mm thick between them.

Finite element analysis (FEA) was conducted on designs (a)-(d). The dimensions of components modeled in the FEA are shown in Table 1 and Table 2.

TABLE 1
Dimensions of magnet and ball screw
components modeled in FEA.

| | | NdFeB Magnets | | |
|---|---|---|---|---|
| Design | Diameter of | External | Internal | Axial |
| Configuration | ball screw 160 | Diameter | Diameter | Thickness |
| Design (a) | ⅜″ | 55 mm | 25 mm | 20 mm |
| Design (a), (b), | ¾″ | 100 mm | 50 mm | 25 mm |
| (c), (d) | | | | |

TABLE 2
Dimensions of pole pieces and cylinder
components modeled in FEA.

| | | Radial | Axial | Axial |
|---|---|---|---|---|
| | | thickness | thickness | thickness |
| | Diameter | of | of pole | of middle |
| Design | of ball | cylinder | piece | pole |
| Configuration | screw 160 | 225 | 274 | piece 275 |
| Design (a) | ⅜″ | 5 mm | 5 mm | 10 mm |
| Design (a) | ¾″ | 20 mm | 10 mm | 20 mm |
| Design (b), (c) | ¾″ | 10 mm | 10 mm | 20 mm |
| Design (d) | ¾″ | 10 mm | 10 mm | 10 mm |

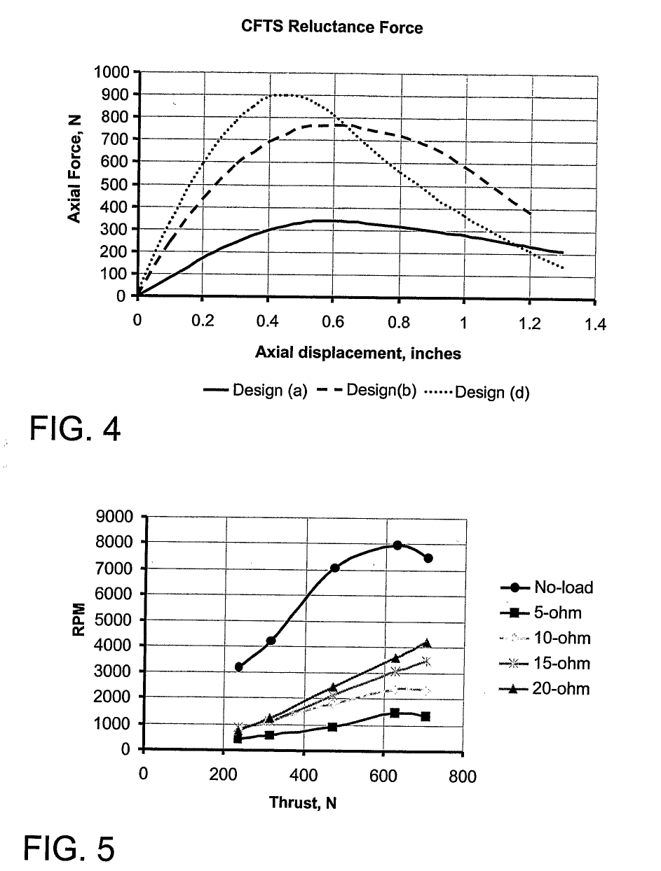

The results of computed force capability as functions of displacement between piston assembly 270 and cylinder 225 are given in FIG. 4. (Results for design (c) are not shown, but its performance was very similar to that of design (b).) As shown in the FEA results of FIG. 4, the peak thrust of the design (d) is higher than that of design (b). The peak thrust is obtained at a displacement approximately equal to one magnetic pole dimension. However, the thrust characteristics of design (b) are wider than that of design (d), with high thrusts distributed over a wider range of axial displacement.

The difference in the characteristics of designs (b) and (d) can be attributed to saturation of the central pole (located approximately at middle pole piece 275) in design (d) compared to design (b) and the effects of flux leakage. In design (d), the effects of saturation of the central pole make the thrust lower compared to design (b) at higher displacements. On the other hand, the relatively large middle pole piece 275 and consequently larger dimensions in design (b) allow for increased leakage which generally reduces the flux density and thrust. Depending on the required application, either curve can be chosen either to increase the peak thrust (design (d)) or to allow adequate vertical travel (design (b)). The peak thrust values of all four configurations, obtained by FEA, are compared in Table 3.

TABLE 3
Peak thrust of design configurations shown in FIG. 3.

| Design | Peak |
|---|---|
| Configuration | Thrust, N |
| Design (a) | 343 |
| Design (b) | 763 |
| Design (c) | 769 |
| Design (d) | 900 |

The results of Table 3 were compared with experimental test results to determine the peak output thrust for two different prototypes, implemented with different ball screw sizes as shown in Table 4.

TABLE 4
Comparison of peak axial thrust from FEA and experimental test data.
Peak Axial Force (N)

| | Design | FEA Model | |
|---|---|---|---|
| Prototype | Configuration | Prediction | Test |
| ⅜″-diameter | Design (d) | 122 | 117.6 |
| ball screw 260 | | | |
| ¾″-diameter | Design (a) | 900 | 894.3 |
| ball screw 260 | | | |

### Experimental Results of the Contact-Less Force Transmission System with Generators

Testing of one embodiment of the CFTS in system 200 was carried out by applying a known thrust to cylinder 225 and measuring the electrical output of generator 292. Two permanent magnet generators, generator #1 and generator #2, were used in testing. Parameters for generator #1 and generator #2 appear in Table 5 and Table 6, respectively.

TABLE 5
Parameters for generator #1.

| | |
|---|---|
| Manufacturer | AMETEK |
| Type | Brushless DC |
| Rated Voltage | 270 V |
| Phase | 3 |
| RPM | 12000 |
| Rs, Xs | 0.43 Ω, 0.19 Ω |

TABLE 6
Parameters for generator #2.

| Manufacturer | MAVILOR MOTORS | |
|---|---|---|
| Type | BS073A00010T.00 | |
| Phase | 3 | |
| BEMF | 241 | V |
| Peak Stall Torque | 13.6 | Nm |
| Continuous Stall Torque | 2 | Nm |
| KT | 0.71 | Nm/A |

| | |
|---|---|
| Max RPM | 5600 |
| Insulation Class | F |
| Resolver | 2T8 |

In a laboratory setting without water, a known thrust was obtained by attaching weights to cylinder 225 and releasing it to accelerate under gravity. The speed measurement was obtained from an oscilloscope capture of the output waveform of generator 292 by measuring its frequency and using the equation for the speed of a synchronous generator

$${n}_{s} = \frac{120 f}{p} \qquad ( 1 )$$

where p is the number of poles and f is the frequency. From the calculated speed, the axial velocity was obtained from the formula

$$Ω = \frac{d z}{d t} \cdot \frac{2 π}{l} [ rad / s ] \qquad ( 2 )$$

using the lead, l, of ball screw 260, where Ω is the mechanical speed of rotation of the shaft and dz/dt is the axial velocity. Input power to this system was the product of the applied thrust and linear velocity. Output power was measured directly as the electrical power was dissipated in resistances that were connected across the generator 292.

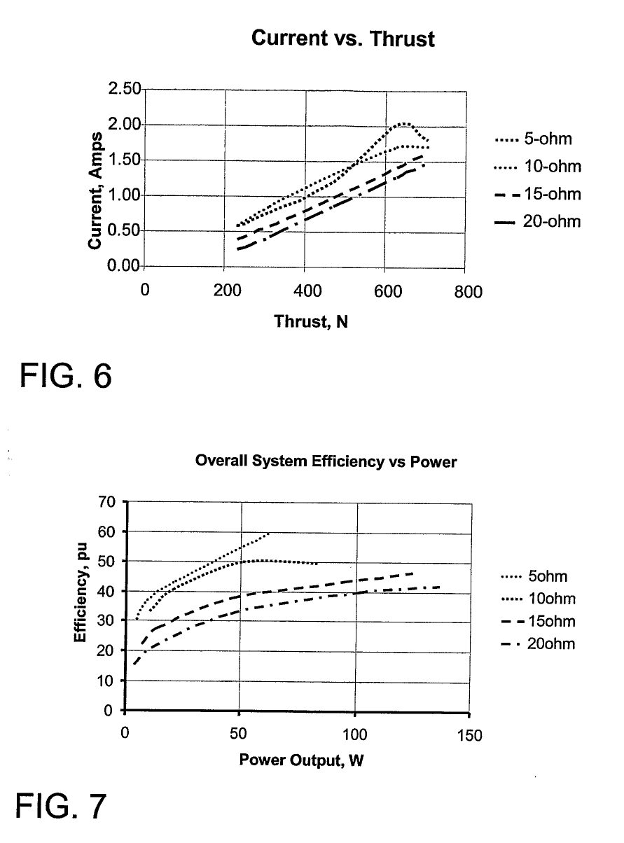

FIGS. 5-7 show test results for system 200 using generator #1. FIG. 5 shows the shaft speed of the generator under loads of 5, 10, 15 and 20 ohms and during no-load operation. Under no-load operation, the higher speeds can result in higher losses and consequently a non-linear speed-thrust characteristic. Under load, the generator speed is much lower and is more linear with thrust. The current increases fairly linearly with the applied thrust as shown in FIG. 6. As seen in FIG. 7, the overall system efficiency is greater than 50% for the 10-ohm load but falls as the electrical load is reduced. Similar curves were obtained using generator #2, except that its high impedance resulted in significant voltage drops and lower power output.

### Computer Simulation of the Buoy Generator System

The buoy generator system 200 of FIG. 2 was simulated in computer software. In this simulation, the equation of motion of the OWEC, in a single degree of freedom (SDOF) heave mode is given by

mᵥ\ddot{z}+bż+cz=F₀ cos(ωt+σ) (3)

where mᵥ=(m+α) is the total virtual mass of the system 200 including an added mass a; b is the damping of the buoy, comprising the hydrodynamic damping of the waves (b_{I}) and the damping provided by generator 292 (b_{G}); c is the spring (buoyancy) constant; F=F₀ cos(ωt+σ) is the exciting force from the waves; z=z₀ cos(ωt) is the heave displacement. The added mass a, hydrodynamic damping b_{I}, and the spring constant c are given for a cylindrical buoy by M. E. McCormick, Ocean Engineering Wave Mechanics, Wiley, 1973.

The damping constant of generator 292 can be determined from the following considerations. The relationship between the torque on the shaft T_{screw} and the axial force F_{screw} for the ball screw 260 is given by,

$$\begin{matrix}{T}_{screw} = \frac{{lF}_{scew}}{2 {πη}_{f}} ( forward driving ) & ( 4 a ) \\ {T}_{screw} = \frac{{lF}_{scew}}{2 π} {η}_{b} ( back driving ) & ( 4 b )\end{matrix}$$

where l=screw lead [m/rev], and where η_{f}, η_{b} are the forward and back drive efficiencies, respectively, of ball screw 260. Generator 292 basically acts like a brake, opposing the rotation with a torque on the shaft that can be expressed as

T_{screw}=K_{T}Ω+T₀ (5)

where T₀ is the loss torque [Nm], K_{T} is the braking coefficient of the generator [Nms/rad], and Q is the angular velocity of the shaft. In an embodiment that uses a permanent magnet synchronous generator (PMSG), the introduction of the constant K_{T} effectively assumes a linear magnetic circuit with no saturation of the rotor and stator iron. With the relatively large effective air gaps (of the magnets themselves) that are common in PMSGs, this assumption does not usually lead to significant errors.

The total force transmitted to the PTO during an upstroke is then given by

$${F}_{screw} = \frac{2 π}{l} ( {K}_{T} Ω + {T}_{0} + {I}_{m G} α ) \qquad ( 6 )$$

where I_{mG} is the moment of inertia of the generator and shaft system, and where for the roller screw

$$Ω = \dot{z} \frac{2 π}{l} ,$$

where ż is linear velocity of ball nut 280 or, similarly, velocity of float 220. Also,

$$α = \frac{d Ω}{d t} = \ddot{z} \frac{2 π}{l}$$

is the angular acceleration of the shaft of generator 292. The generator damping coefficient is given by

$${b}_{G} = {{K}_{T} ( \frac{2 π}{l} )}^{2} \qquad ( 7 )$$

In an embodiment where generator 292 is decoupled, during the down stroke there is no axial force from the PTO on float 220. Generator 292 “free wheels,” i.e., it is decelerated by the electrical load connected to it, its own inertia and that of shaft 294 through the unidirectional clutch 291. In that case, F_{screw}=0 or,

I_{mG}α+T_{screw}=0 (8)

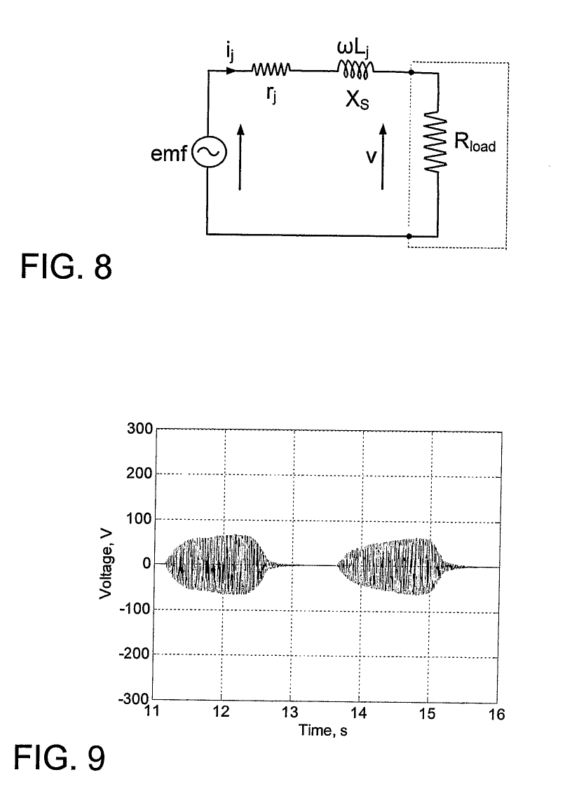

FIG. 8 depicts an equivalent circuit of the PMSG. The voltage across a phase of the generator windings can be expressed as

$${v}_{j} = - {r}_{j} {i}_{j} + {L}_{j} \frac{d {i}_{j}}{d t} + \frac{d {λ}_{jf}}{d t} , \qquad ( 9 )$$

where rⱼ is the phase resistance, iⱼ is the current of j-th phase, λ_{jf} is the flux linkage in phase j due to the permanent magnet, and Lⱼ is phase inductance.

The peak value of the induced emf of the PMSG is dependent on speed and can be expressed as

$${E}_{j} = \frac{d {λ}_{jf}}{d t} = {K}_{f} \cdot Ω .$$

The currents can be obtained by rearrangement and integration of Equation 9, noting that v₁=i₁R_{load}.

FIG. 9 shows a graphs of simulated results for the no-load voltage of generator 292 during operation in waves with a unidirectional clutch action on shaft 294 under wave conditions where the wave period T=2.5 s and the significant wave height Hₛ=0.15 m. During free-wheeling, the voltage produced is zero as clutch 291 disengages generator 292 from the rotation and generator 292 is decelerated. Also, unlike operation under the reciprocating action, with a clutch the voltage time area is generally less symmetrical.

### Wave Flume Testing of the Buoy Generator System

System 200 (with a ¾″-diameter ball screw 260) was tested in a wave flume. The wave flume that was used is 7 feet deep, 30 feet wide, 110 feet long and tapers to a typical beach. There are two sets of hydraulically driven wave makers that are activated in sequence to create irregular waves of approximately 4 feet in height and with approximately four-second dominant periods. System 200 was tested in irregular waves. This particular embodiment was made up of system 200, with the addition of a rigid shaft between spar 210 and a mooring plate. The shaft was also equipped with a swivel joint that allowed motion in six degrees of freedom. However, the threaded studs of the swivel joint were adjustable to provide a stiff rigid member. For this embodiment, spar 210 is about 1.68 m (5.5 feet) long, and float 220 has an outer diameter of about 0.6 m and is about 0.6 m long.

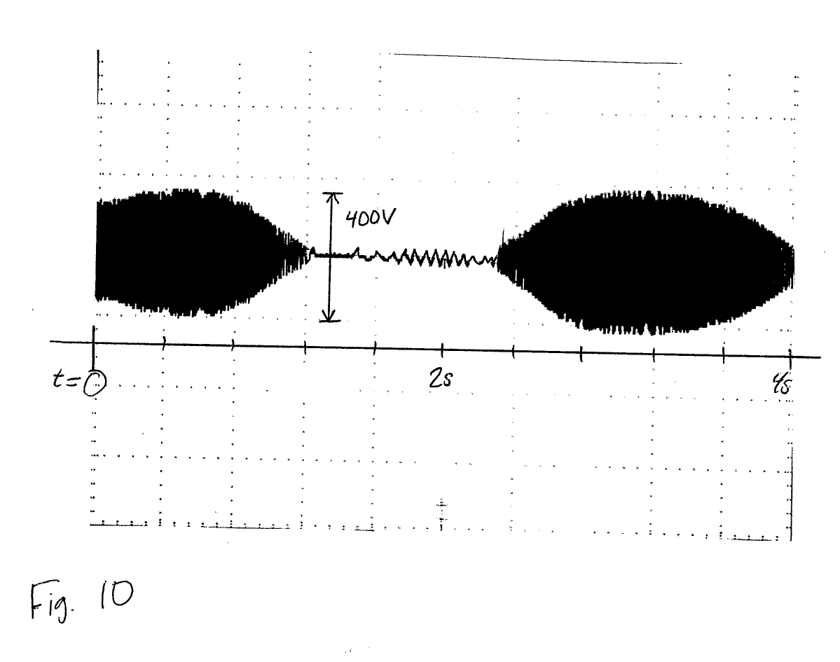

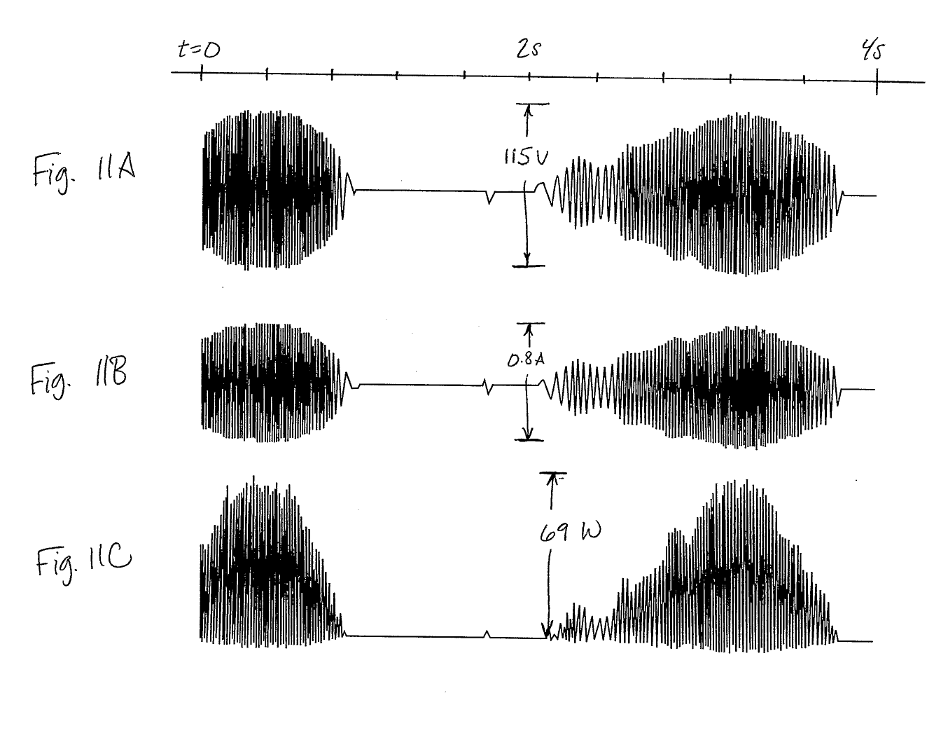

FIG. 10 is an oscilloscope capture showing the no-load voltage output of generator 292 during the up-stroke and down-stroke portions of the wave cycle. Because clutch 291 was uni-directional in this tested embodiment, generator 292 free-wheels on the down stroke and no voltage is generated. FIGS. 11A-11C show example oscilloscope captures of system 200 operating into a 75-ohm load. FIGS. 11A-11C show waveforms for voltage, current, and power outputs, respectively. The peak output power under load was about 69 W. The generator used in the tested embodiment (generator #1) has a high synchronous reactance and a high voltage drop. A generator model of relatively lower impedance can improve output power.

Wave flume test results for generator outputs under various load conditions are summarized in Table 7.

TABLE 7
Wave flume test results.

| Load | Voltage | Current | Power |
|---|---|---|---|
| Resistance | (Vp) | (Ip) | (Wp) |
| ohm | V | A | W |
| 20 | 16 | 0.5 | 6 |
| 30 | 35 | 0.7 | 18.4 |
| 50 | 52 | 0.6 | 23.4 |
| 75 | 65 | 0.6 | 29.3 |

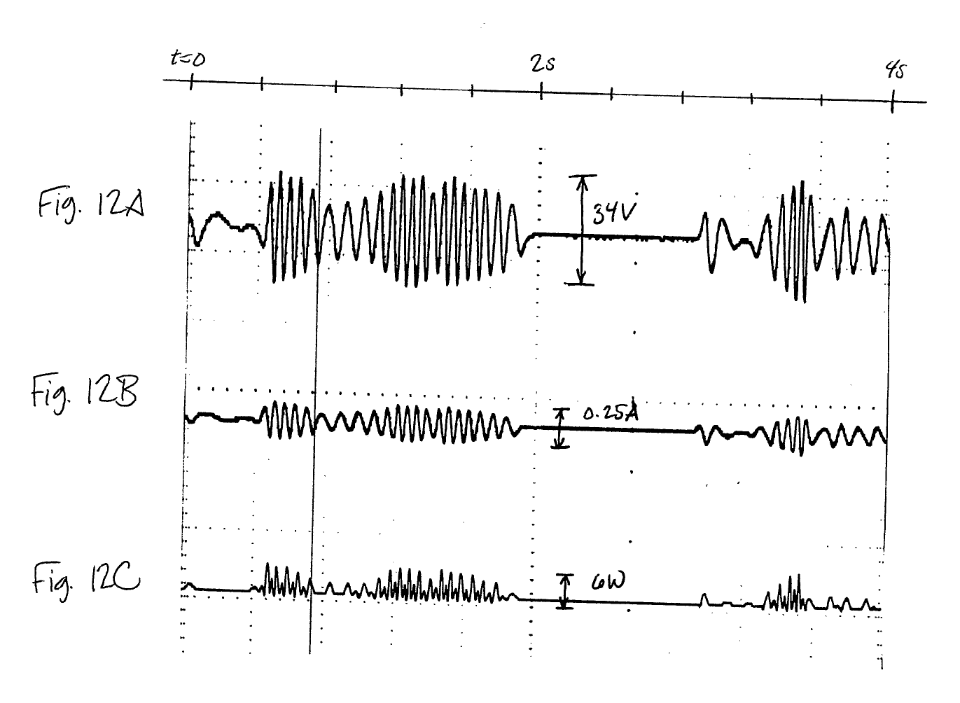

FIGS. 12A-12C show waveforms (for voltage, current, and power, respectively) caused by irregular motion of spar 210 due to irregular wave excitation. In another embodiment, these effects are reduced using a dynamic control system.

### System Using a Permanent Magnet Helical Screw Drive

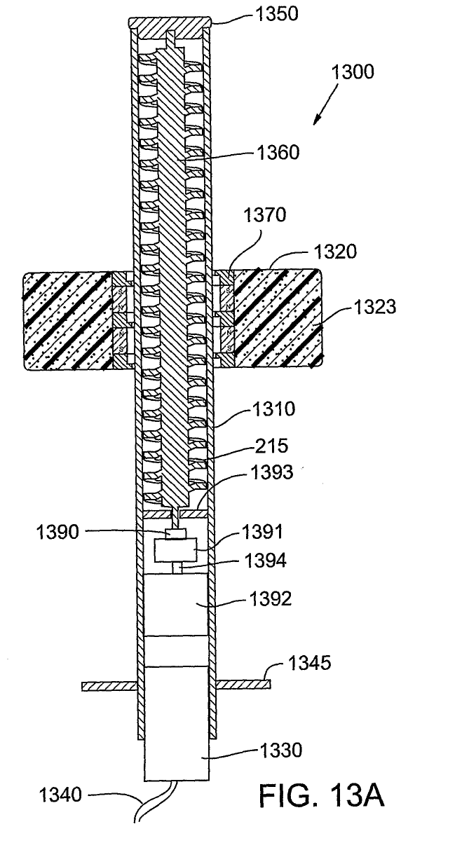

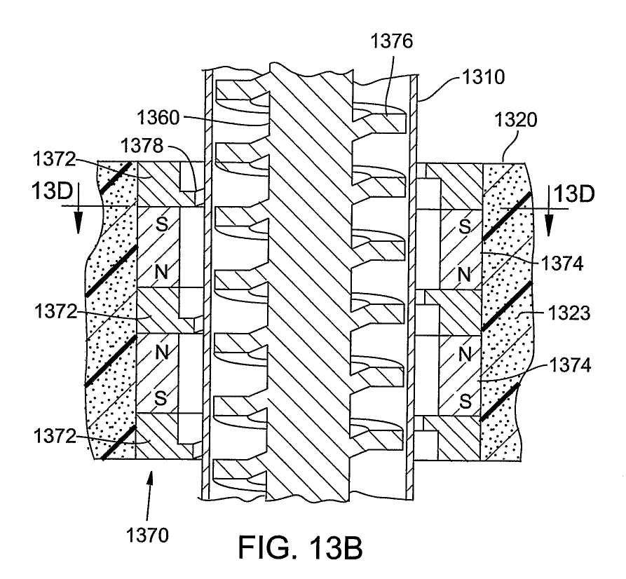

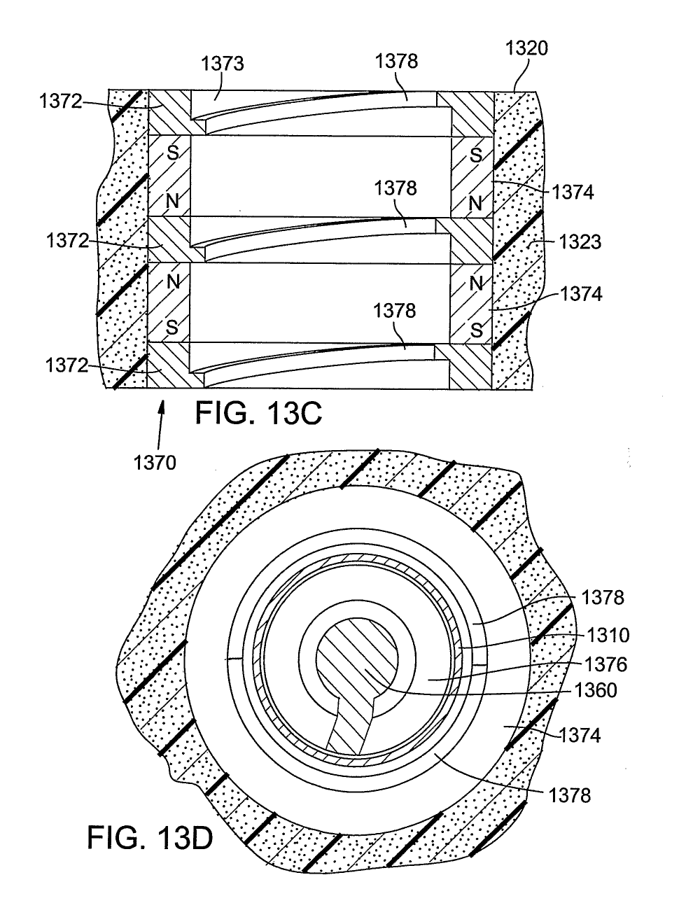

FIG. 13A shows a cross-section side view of another embodiment of system 100. System 1300 comprises a float 1320 which is approximately coaxial with a tube-like spar 1310. Float 1320 comprises air or other buoyant material 1323 and a magnet assembly 1370, which is described in more detail below. Float 1320 preferably encircles spar 1310 a full 360 degrees, but it can also encircle spar 1310 less than 360 degrees. Similar to other embodiments described above, spar 1310 can be comprised of a material that can withstand ocean conditions for a relatively long period of time, such as PVC or composite material. System 1300 can further comprise a cap 1350, a generator 1392 with a shaft 1394, a clutch 1391 (uni- or bi-directional), a coupling 1390, a protective plate 1393, a ballast weight 1330, and a wave plate 1345. System 1300 can be secured to an anchor or mooring system by a tether 1340. Spar 1310 contains at least one center screw 1360, which is preferably approximately coaxial with spar 1310. Center screw 1360 is comprised of one or more materials that exhibit high electrical resistance and low magnetic reluctance, such as an alloy comprising about 1-4% silicon steel. As is known in the art, what constitutes “high electrical resistance and low magnetic reluctance” varies from application to application.

FIG. 13B shows center screw 1360 and surrounding magnet assembly 1370 in more detail. Center screw 1360 comprises threads such as thread 1376, which desirably run at least part of the length of center screw 1360. The threads can have a flat face (i.e., outer surface) and a vertical wall angle, although other face designs and wall angles can also be used. Characteristics of threads 1376 (e.g., pitch, spacing) can be chosen based on a particular application. A choice of thread pitch can be weighed against thrust and speed requirements of system 1300.

FIG. 13C shows magnet assembly 1370 in more detail, without spar 1310 and center screw 1360. Magnet assembly 1370 comprises two or more pole shoes 1372, which are arranged generally concentrically with spar 1310. Pole shoes 1372 can comprise a generally circular or generally semi-circular main piece 1373 and can have a thread 1378 extending along part or all of the inside of main piece 1373. Pole shoes 1372 and threads 1378 can extend 360 around the inside of float 1320, or they can extend less than 360 degrees around. In one embodiment, a pole shoe 1372 can be comprised of two or more pole shoe pieces of smaller angular size. The pole shoe pieces can be placed adjacent to each other in an axial plane or, if their size permits, they can be placed non-adjacent in an axial plane. For example, a pole shoe which extends 360 degrees can be comprised of two 180-degree shoes. Pole shoes 1372 are comprised of one or more materials that exhibit high electrical resistance and low magnetic reluctance, such as a silicon iron alloy. Characteristics of threads 1378 (e.g., pitch, spacing) can be chosen based on a particular application. Pitch of threads 1376 can be selected to amplify or reduce the angular speed of a turning center screw 1360. A choice of thread pitch can be weighed against thrust and speed requirements of system 1300. Preferably, between two pole shoes 1372 is a ring magnet 1374. One or more pairs of ring magnets 1374 can be used to create complementary flux densities. In one embodiment, several ring magnets 1374 are stacked axially adjacent to each other with their poles in the same orientation. If desired, threads 1378, ring magnets 1374 and pole shoes 1372 can be coated with an insulator, preferably a non-conductive, non-corrosive, high-strength, non-magnetic insulation (not shown).

FIG. 13D depicts a top cross-sectional view taken along the line 13D-13D indicated in FIG. 13B. This embodiment shows ring magnet 1374 and the threads 1378 from two 180-degree pole shoes 1372. (In this view, ring magnet 1374 hides most of the pole shoes 1372 except for threads 1378.)

Returning to FIG. 13A, when relative linear motion occurs between float 1320 and spar 1310 (e.g., when a wave exerts a force on float 1320), magnet assembly 1370 moves in a linear direction relative to center screw 1360. This causes a differential in magnetic flux between center screw 1360 and pole shoes 1372. This differential flux can result in transaxial forces which pull on screw 1360, causing it to rotate back into alignment with pole shoes 1372. This can create relative rotary motion between center screw 1360 and magnet assembly 1370. As a result, center screw 1360 turns clutch 1391 and shaft 1394 on generator 1392, creating an electric current.

Generally, center screw 1360 and magnet assembly 1370 can operate bi-directionally. For example, rotary motion can be converted to linear motion by applying a torque to center screw 1360 or magnet assembly 1370 (or to both). This rotary motion can cause a differential flux (similar to that described above) resulting in a linear motion.

Although the magnet assembly 1370 and center screw 1360 are described above with respect to an ocean wave energy converter, this combination can be used more generally for applications involving a conversion between linear motion and rotary motion. For example, many applications currently using ball screw assemblies can be redesigned using a magnet assembly 1370 and center screw 1360. This approach can allow for: less acoustic noise (particularly for operations at relatively high speeds); less wear and maintenance; recovery from overloads with little or no maintenance; amplification of speed or torque (depending upon a “gear ratio”); and improvements in energy transfer efficiency, as losses can generally be limited to radial bearing friction and magnetic hysteresis losses.

### System Featuring Multiple Spars

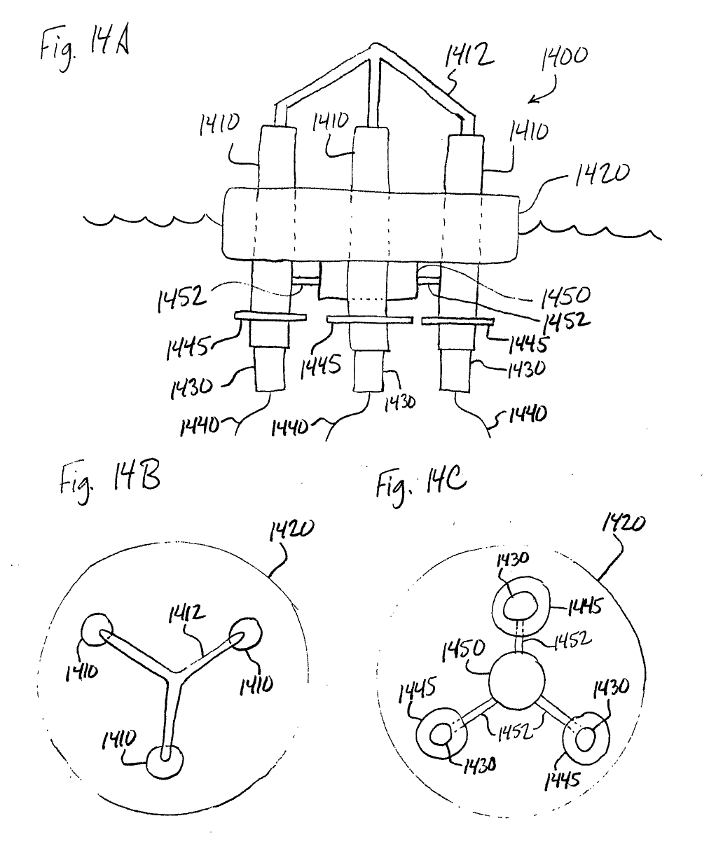

FIG. 14A depicts an ocean wave energy converter system 1400, which comprises a float 1420 and two or more spars 1410. The particular embodiment shown features three spars 1410 surrounded by float 1420. Spars 1410 are reinforced from above by support structure 1412, but in other embodiments a support structure on the underside of system 1400 can be added. In another embodiment no support structure is present. Spars 1410 and float 1420 together comprise systems similar to those described previously in this application, e.g., system 200 using the CFTS with either a ball screw or a roller screw, or system 1300 using permanent magnets and the helical center screw. Similar to other embodiments described above, ballast weights 1430 and wave plates 1445 can be attached to spars 1410, and the spars can be held in place using tethers 1440. The top ends of the spars 1410 can have caps as in other embodiments, although they are not shown in FIG. 14A.

In one embodiment, individual spars 1410 contain a generator (not shown), similar to the systems described above. In another embodiment, spars 1410 transfer rotary energy through a gear system 1452 (or other energy transmission system) to turn a generator 1450. Harnessing the rotary energy from two or more spars can allow for improved scalability of a multiple-spar system and can also allow for higher generator speeds.

FIG. 14B provides a top view of system 1400, showing float 1420, spars 1410 and support structure 1412. FIG. 14C is a bottom view of system 1400, showing generator 1450 and gear system 1452, as well as float 1420, ballast weights 1430 and wave plates 1445.

In view of the many possible embodiments to which the principles of the disclosed invention can be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

1. A system for converting wave motion to rotary motion, wherein the system is at least partially immersed in a liquid, the system comprising:
a first component, the first component having an overall buoyancy relative to the liquid;
a second component slidably coupled to the first component; and
at least one screw rotatably supported by the second component, wherein the first component is configured to slide relative to the second component in response to a force from waves that is exerted on the first component, wherein the first component is magnetically coupled to the screw, and wherein sliding of the first component relative to the second component in at least one direction causes a rotation of the screw.

2. The system of claim 1, wherein the sliding of the first component relative to the second component comprises relative linear motion.

3. The system of claim 1, wherein the first component comprises a ferrous metal, wherein the second component further comprises a magnet and a ball screw nut, wherein the ball screw nut is generally coaxial with the screw, and wherein the ferrous metal is configured to transfer the force to the ball screw nut through the magnet.

4. The system of claim 1, wherein the second component further comprises a generator, and wherein the screw is configured to transfer rotary motion of the screw to the generator.

5. The system of claim 1, wherein the magnet is one of a plurality of magnets, and wherein at least two magnets of the plurality of magnets are separated by a metal pole piece.

6. (canceled)

7. The system of claim 1, wherein the ferrous metal of the first component is generally cylindrical in shape.

8. The system of claim 6, wherein the ferrous metal of the first component comprises one or more salient features.

9. The system of claim 1, wherein the first component further comprises a magnet, wherein the second component further comprises a ferrous metal mechanically coupled to a ball screw nut, and wherein the magnet is configured to transfer the force to the ball screw nut through the ferrous metal.

10. The system of claim 1, wherein the first component comprises a ferrous metal, wherein the second component further comprises a magnet and a roller screw nut, wherein the roller screw nut is generally coaxial with the screw, and wherein the ferrous metal is configured to transfer the force to the roller screw nut through the magnet.

11. The system of claim 1, wherein the second component is one of two or more second components.

12. The system of claim 10, further comprising:
a generator; and
an energy transmission system configured to transfer energy from the screws of the two or more second components to the generator.

13. The system of claim 1, wherein the first component comprises a float, and wherein the second component comprises a spar and is approximately neutrally buoyant relative to the liquid.

14. (canceled)

15. (canceled)

16. The system of claim 1, wherein the second component comprises a generator coupled to the screw and adapted to generate electricity in response to rotation of the screw, the system further comprising electrical conductors configured to transmit electricity to a location that is remote from the first and second components.

17. (canceled)

18. The system of claim 1, wherein the first component comprises one or more magnets, and wherein the screw comprises one or more materials exhibiting generally high electrical resistance and generally low magnetic resistance.

19. The system of claim 17, wherein the screw comprises a silicon iron alloy.

20. The system of claim 17, wherein the first component further comprises at least two pole shoes adjacent to the one or more magnets, wherein the pole shoes comprise a main piece and a thread, and wherein the thread extends along at least part of the main piece.

21. The system of claim 19, wherein the main piece has a length, and wherein the thread extends in a generally non-parallel manner along at least part of the length.

22. The system of claim 19, wherein the at least two pole shoes comprise a first pole shoe with a top side and a bottom side, wherein the one or more magnets comprise a first magnet having a north pole and a south pole and a second magnet having a north pole and a south pole, and wherein the north pole of the first magnet is adjacent to the top side of the first pole shoe and the north pole of the second magnet is adjacent to the bottom side of the first pole shoe.

23. The system of claim 19, wherein the at least two pole shoes are comprised of one or more materials exhibiting generally high electrical resistance and generally low magnetic resistance.

24. (canceled)

25. An ocean wave energy conversion system comprising:
a float; and
a spar comprising a tube and a screw inside the tube, wherein the float and the spar are configured to undergo relative linear motion as a result of a force applied to the float, and wherein the relative linear motion causes the kinetic energy to be transferred from the float to the screw substantially without a mechanical connection between the float and the spar.

26. The ocean wave energy conversion system of claim 24, wherein the float is magnetically coupled to the spar.

27. The ocean wave energy conversion system of claim 25, wherein the float is configured to become magnetically decoupled from the spar when a threshold force is applied to the float.

28. The ocean wave energy conversion system of claim 24, the system further comprising a generator mechanically coupled to the screw.

29. A system for converting wave motion to electricity, wherein the system is at least partially immersed in a liquid, the system comprising:
a float, the float having an overall buoyancy relative to the liquid;
a spar, the spar having an approximately neutral buoyancy relative to the liquid;
a screw rotatably supported by the spar component; and
a generator, wherein the float is configured to undergo linear movement relative to the spar in response to a force from waves that is exerted on the float, wherein the float is magnetically coupled to the screw, wherein the movement of the float relative to the spar causes a rotation of the screw, and wherein the screw is configured to transfer rotary motion of the screw to the generator.

30. The system of claim 28, further comprising a clutch, wherein the clutch is mechanically coupled to the screw and the generator.
